(19) United States
(12) Patent Application Publication
(10) Pub. No.: US 2011/0025823 A1
(43) Pub. Date: Feb. 3, 2011

(54) Three-dimensional measuring apparatus

(75) Inventor: Yoshihiro Sasaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Renesas Electronics Corporation, Kawasaki-shi (JP)

(21) Appl. No.: 12/805,387

(22) Filed: Jul. 28, 2010

(30) Foreign Application Priority Data
Aug. 3, 2009 (JP) 2009-181059

(51) Int. Cl. H04N 13/02

(52) U.S. Cl. 348/46; 348/E13.074

(57) ABSTRACT

A three-dimensional measuring apparatus includes a measurement stage on which an object is placed, a reference scale member having a plurality of reference points, an imaging unit, a driving mechanism, a high brightness detecting unit, and a three-dimensional measuring unit. The imaging unit captures an optical image of the object and the optical images of the plurality of reference points in the same field of view. The high brightness detecting unit detects the brightest portion of the object at each of N relative movement positions of the imaging unit and detects a reference point indicating the maximum brightness among the plurality of reference points, from a plurality of images that is continuously captured by the imaging unit. The three-dimensional measuring unit sets the height of the brightest portion at each of the relative movement positions to a height associated with the detected reference point.

This application is based on Japanese patent application No. 2009-181059, the content of which is incorporated hereinto by reference.

### BACKGROUND

1. Technical Field

The present invention relates to a technique that emits light to an object, receives reflected light, and measures a three-dimensional shape of the object, and more particularly, to a technique that captures the image of an object using a solid-state imaging device and measures the three-dimensional shape of the object based on the captured image.

2. Related Art

A technique that captures the image of an object using a solid-state imaging device, such as a CCD or a CMOS, and measures the three-dimensional shape of the object based on the captured image (hereinafter, referred to as a ‘three-dimensional measurement technique’) has been widely used in the field of manufacturing electronic parts, such as semiconductor devices. In recent years, with the miniaturization of electronic parts, there has been a demand for measurement accuracy in the submicron range. For example, in the case of an LSI chip that is mounted on a substrate by a flip-chip mounting technique, a plurality of solder bumps for bonding the LSI chip to amounting substrate is arranged in an array on the LSI chip. Before the LSI chip is mounted, a process of measuring the three-dimensional shape of the solder bumps and examining whether there is a defect is performed.

For example, Japanese Laid-open patent publication NO. 2004-226331 or Japanese Laid-open patent publication NO. 2004-286533 discloses a technique related to three-dimensional measurement. Japanese Laid-open patent publication NO. 2004-226331 discloses a three-dimensional measurement technique using a triangulation method that obliquely emits projection light, such as a laser beam, to an object, detects reflected light using a light receiving sensor, and detects the height of the object. Japanese Laid-open patent publication NO. 2004-286533 discloses a three-dimensional measurement technique using a confocal optical system.

The three-dimensional measuring apparatus disclosed in Japanese Laid-open patent publication NO. 2004-226331 includes a moving mechanism that moves a base on which an object is placed in an X-axis direction and a Y-axis direction vertical to the height direction, and the moving mechanism controls the emission position of the projection light on the object. However, the three-dimensional measuring apparatus requires an expensive illuminating unit that emits the projection light with high accuracy and the triangulation method is used to detect the height of the object. So, there is a limitation in detection accuracy.

The three-dimensional measuring apparatus disclosed in Japanese Laid-open patent publication NO. 2004-286533 includes an XYZ stage that moves an object (sample) in the X-axis direction, the Y-axis direction, and the Z-axis direction (height direction), a light source, a confocal optical system, a CCD camera, a scale, and a computer. The scale is for reading a movement position of the XYZ stage in the Z-axis direction and outputting the movement position as a scale value. In the three-dimensional measuring apparatus, light reflected from the object is incident on the CCD camera through the confocal optical system. While the XYZ stage moves the object in the Z-axis direction at a constant speed, the CCD camera continuously captures the image of the object and generates a plurality of captured images. The computer associates the brightness distribution of the captured images with the scale value to calculate the height of the object.

The three-dimensional measuring apparatus disclosed in Japanese Laid-open patent publication NO. 2004-286533 uses the confocal optical system. Therefore, it is possible to obtain detection accuracy higher than that of the measurement technique disclosed in Japanese Laid-open patent publication NO. 2004-226331. However, since there is a backlash, non-uniformity in frictional resistance, and variation over time in a transport mechanism in the Z-axis direction, there are limitations in accurately controlling the amount of movement according to a control pulse. In order to achieve a measurement accuracy of 0.1 μm or 0.01 μm, the amount of movement in the Z-axis direction must be accurate. Therefore, it is necessary to highly accurately measure the amount of movement in the Z-axis direction using an accurate measuring device, such as an optical linear scale, which causes a complicated structure of an apparatus and an increase in manufacturing costs.

### SUMMARY

In one embodiment, there is provided a three-dimensional measuring apparatus including a measurement stage on which an object is placed, a reference scale member having a plurality of reference points, an imaging unit that is arranged so as to face the measurement stage and captures an optical image of the object and optical images of the plurality of reference points in the same field of view, a driving mechanism that moves the imaging unit relative to the measurement stage in a direction in which the imaging unit is separated from or approaches the measurement stage, a high brightness detecting unit that detects the brightest portion of the object at each of N relative movement positions (N is an integer that is equal to or greater than 2) of the imaging unit and detects a reference point indicating the maximum brightness among the plurality of reference points, from a plurality of images that is continuously captured by the imaging unit during a driving period for which the driving mechanism relatively moves the imaging unit, and a three-dimensional measuring unit that sets the height of the brightest portion at each of the relative movement positions to a height associated with the detected reference point.

In the three-dimensional measuring apparatus, the imaging unit continuously captures the optical image of the object and the optical images of a plurality of reference points of the reference scale member in the same field of view while being moved relative to the measurement stage in the direction in which it is separated from or approaches the measurement stage. The high brightness detecting unit and the three-dimensional measuring unit detect the brightest portion of the object and a reference point indicating the maximum brightness, which corresponds to the brightest portion, at each relative movement position and set the height of the brightest portion of the object to a height associated with the detected reference point. When the positions of a plurality of reference points of the reference scale member are accurately measured in advance and a measured value, which is the measurement result, is associated with each reference point, it is possible to accurately measure the height distribution of the object. Therefore, it is possible to accurately measure the three-dimensional shape of the object without accurately measuring the amount of movement of the imaging unit using an accurate measuring device such as an optical linear scale.

It is possible to simplify the structure of an apparatus and reduce manufacturing costs.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram schematically illustrating the structure of a three-dimensional measuring apparatus according to a first embodiment of the invention;

FIG. 2A is a perspective view illustrating a first example of a reference scale member;

FIG. 2B is a side view illustrating the reference scale member;

FIG. 3A is a side view illustrating a second example of the reference scale member;

FIG. 3B is a right side view illustrating a reference plate of the reference scale member shown in FIG. 3A;

FIG. 3C is a front view illustrating the reference plate;

FIG. 4A is a side view illustrating a third example of the reference scale member;

FIG. 4B is a right side view illustrating a reference plate of the reference scale member shown in FIG. 4A;

FIG. 4C is a front view illustrating the reference plate;

FIG. 5A is a side view illustrating a fourth example of the reference scale member;

FIG. 5B is a right side view illustrating a base plate and a reference plate of the reference scale member shown in FIG. 5A;

FIG. 5C is a front view illustrating the base plate and the reference plate; and

FIG. 6 is a diagram schematically illustrating the structure of a three-dimensional measuring apparatus according to a second embodiment of the invention.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Hereinafter, exemplary embodiments of the invention will be described with reference to the accompanying drawings.

### First Embodiment

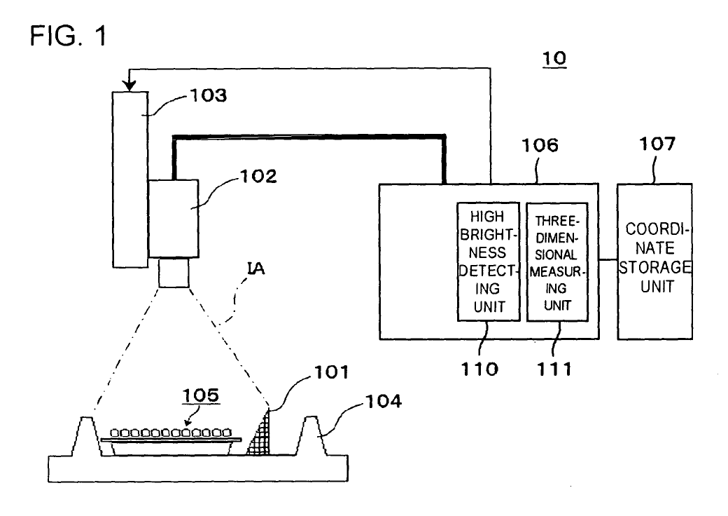

FIG. 1 is a diagram schematically illustrating the structure of a three-dimensional measuring apparatus 10 according to a first embodiment of the invention. The three-dimensional measuring apparatus 10 includes a measurement stage 104, a reference scale member 101, an imaging unit 102, a driving mechanism 103, a detection control unit 106, and a coordinate storage unit 107. The detection control unit 106 includes a high brightness detecting unit 110 and a three-dimensional measuring, unit 111. An object 105 and the reference scale member 101 are mounted on a mounting surface of the measurement stage (base portion) 104.

The imaging unit 102 is provided so as to face the measurement stage 104 and has a function of capturing the optical image of the object 105 and the optical images of a plurality of reference points λ₁, . . . , λ_{L} (L is a positive integer that is equal to or greater than 2) of the reference scale member 101 in the same field of view IA. Two-dimensional image data of N×M pixels (N and M are positive integers) captured by the imaging unit 102 is transmitted and processed by the detection control unit 106.

The imaging unit 102 includes a solid-state imaging device, such as a CCD or a CMOS, a fixed focus lens, and an eqi-illumination mechanism (which are not shown). The eqi-illumination mechanism uniformly emits light to the object 105 and the reference scale member 101. It is preferable that the eqi-illumination mechanism be a coaxial eqi-illumination mechanism (a mechanism emitting light that is substantially parallel to the optical axis of the imaging unit 102) in order to uniformly emit light to improve the accuracy of measuring the three-dimensional shape of the object 105. The imaging unit 102 may include an optical system provided in the microscope according to the related art or an optical system capable of detecting light according to a principle, such as a light confocal method or an optical interference fringe method.

The driving mechanism 103 has a mechanism of moving the imaging unit 102 relative to the measurement stage 104 in the Z-axis direction in which the imaging unit 102 is separated from or approaches the measurement stage 104, in response to a control signal from the detection control unit 106. With the movement of the imaging unit 102, the focal point of the imaging unit 102 is also moved in the Z-axis direction. When the imaging unit 102 is focused on a certain portion of the surface of the object 105, the brightness of the portion of the surface in the image captured by the imaging unit 102 is more than that of the other portions of the surface, and the portion is displayed as the brightest portion of the surface of the object 105.

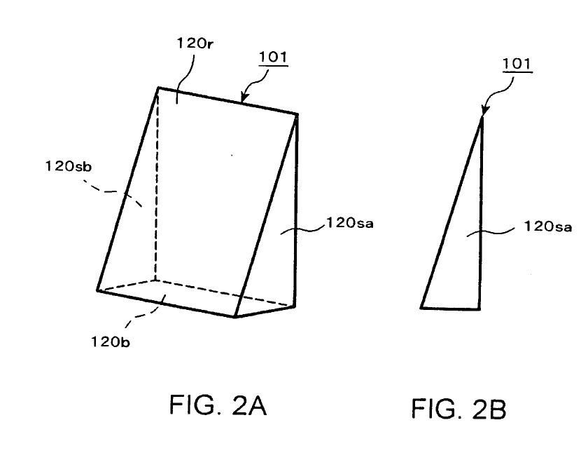

FIG. 2A is a perspective view illustrating an example of a triangular prism member 101, which is a reference scale member, and FIG. 2B is a diagram illustrating one of the side surfaces 120sa and 120sb of the reference scale member 101 shown in FIG. 2A. The reference scale member 101 has a bottom 120b that comes into contact with the mounting surface of the measurement stage 104 and a measurement reference surface 120r, which is an inclined plane that is inclined at an acute angle with respect to the bottom. The measurement reference surface 120r is polished such that surface accuracy is improved and is a flat surface.

A plurality of reference points λ₁, . . . , λ_{L} (L is a positive integer that is equal to or greater than 2) is provided on the measurement reference surface 120r in the range from the bottom 120b to the upper end. The reference points λ₁, . . . , λ_{L} are not physically formed on the measurement reference surface 120r. Therefore, the reference points λ₁, . . . , λ_{L} are specified by the coordinates on the measurement reference surface 120r.

The heights of the reference points λ₁, . . . , λ_{L} from the mounting surface (or the heights from the bottom 120b) are accurately measured in advance. The coordinates indicating the accurately measured heights are stored in the coordinate storage unit 107 so as to be associated with the reference points λ₁, . . . , λ_{L}.

It is preferable that the reference scale member 101 be made of a material with little variation over time (for example, metal, glass, or ceramics). The reference scale member 101 is manufactured such that the accuracy of the measured data is valid in a certain temperature range for several years after the heights of the reference points λ₁, . . . , λ_{L} are accurately measured once.

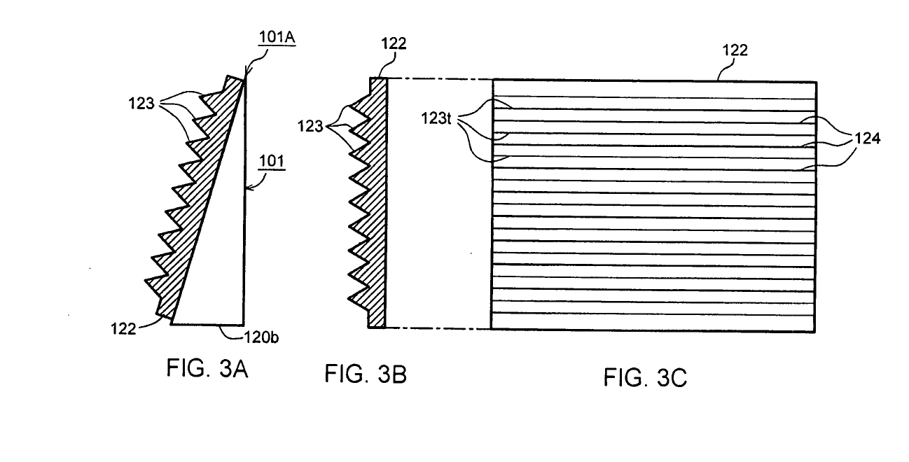

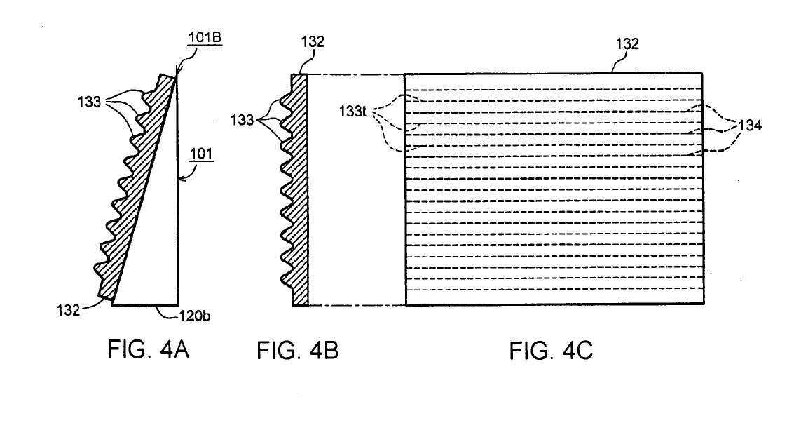

Instead of the reference scale member 101 having the flat measurement reference surface 120r shown in FIG. 2A, a reference scale member having a measurement reference surface including a plurality of convex portions may be used. FIGS. 3A, 3B, and 3C are diagrams illustrating the schematic structure of a reference scale member 101A including convex portions 123 that form a sawtooth cross-section. FIGS. 4A to 4C are diagrams illustrating the schematic structure of a reference scale member 101B including convex portions 133 that form the surface of a corrugated plate.

The reference scale members 101A and 101B are formed by attaching reference plates 122 and 132 to the inclined planes of the triangular prism members 101 shown in FIGS. 2A and 2B, respectively. The reference plates 122 and 132 may be formed by processing the surface of a quartz glass plate using etching such as photo-etching.

FIG. 3A is a side view illustrating the reference scale member 101A, FIG. 3B is a right side view illustrating the reference plate 122 of the reference scale member 101A, and FIG. 3C is a front view illustrating the reference plate 122. As shown in FIG. 3C, the tops 123t of the convex portions 123 shown in FIG. 3B are continuously formed at a predetermined interval from one end of the reference plate 122 to the other end thereof. In addition, a groove 124 is formed every between the tops 123t of the convex portions 123. The reference plate 122 is attached to the inclined plane of the triangular prism member 101 such that the convex portions 123 extend in a direction parallel to the bottom 120b.

The reference points λ₁, λ₂, . . . with different heights (distances from the bottom 120b) may be provided at the tops 123t of the convex portions 123. When the imaging unit 102 captures the image of the reference scale member 101A that is placed on the measurement stage 104 shown in FIG. 1, it is possible to detect a plurality of convex portions 123 formed on the surface of the reference plate 122 from the captured image. It is preferable that the convex portions 123 be formed so as to have a step difference of, for example, 0.1 μm to 0.01 μm in the height direction from the bottom 120b.

FIG. 4A is a side view illustrating the reference scale member 101B, FIG. 4B is a right side view illustrating the reference plate 132 of the reference scale member 101B, and FIG. 4C is a front view illustrating the reference plate 132. As shown in FIG. 4C, the tops 133t of the convex portions 133 shown in FIG. 4B are continuously formed at a predetermined interval from one end of the reference plate 132 to the other end thereof. In addition, a groove 134 is formed every between the tops 133t of the convex portions 133. The reference plate 132 is attached to the inclined plane of the triangular prism member 101 such that the convex portions 133 extend in a direction parallel to the bottom 120b.

The reference points λ₁, λ₂, . . . , with different heights (distances from the bottom 120b) may be provided at the tops 133t of the convex portions 133. It is preferable that the convex portions 133 be formed so as to have a step difference of, for example, 0.1 μm to 0.01 μm in the height direction from the bottom 120b.

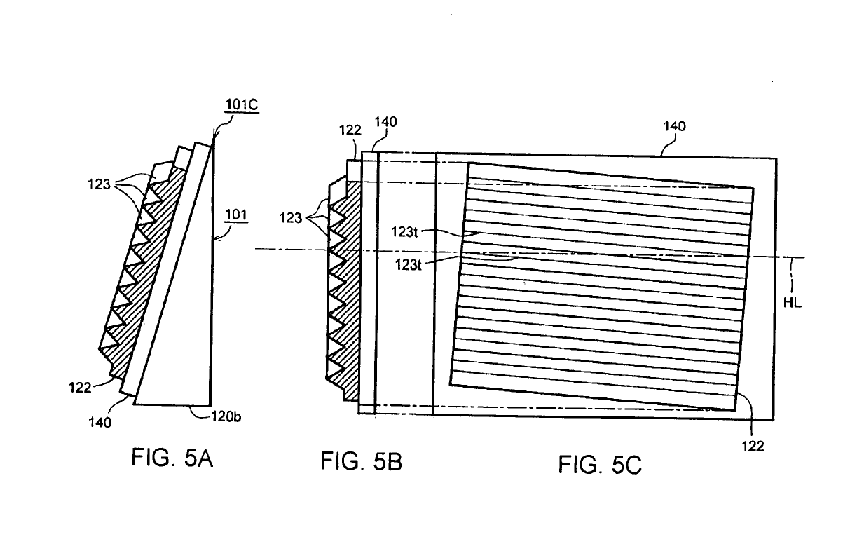

The convex portions 123 and 133 of the reference scale members 101A and 101B are arranged so as to extend in the same direction as that in which the bottom 120b extends. Therefore, it is difficult to provide a plurality of reference points with different heights at the convex portions 123 or 133. However, when the convex portions 123 and 133 are arranged so as to be inclined at an angle of several degrees with respect to the bottom 120b, it is possible to provide a plurality of reference points with different heights at the convex portions 123 or 133. FIG. 5A is a side view schematically illustrating a reference scale member 101C including convex portions 123 that are inclined with respect to the bottom 120b of the triangular prism member 101.

FIG. 5B is a right side view illustrating a base plate 140 and a reference plate 122 of the reference scale member 101C and FIG. 5C is a front view illustrating the base plate 140 and the reference plate 122. As shown in FIGS. 5B and 5C, the reference plate 122 is attached to the upper surface of the base plate 140. As shown in FIG. 5A, the rear surface of the base plate 140 is attached to the inclined plane of the triangular prism member 101 and the convex portions 123 are arranged so as to continuously extend in a direction that is inclined with respect to the bottom 120b of the triangular prism member 101.

The base plate 140 is attached to the triangular prism member 101 such that a horizontal reference line HL shown in FIG. 5C which determines the inclination angle of the convex portions is parallel to the bottom 120b of the triangular prism member 101. As shown in FIG. 5C, the horizontal reference line HL is formed so as to link the left end of the lower top 123t and the right end of the upper top 123t of the tops 123t of adjacent convex portions 123. Therefore, the distance between one end of a k-th convex portion (k is an integer) among the convex portions 123 shown in FIG. 5A and the bottom 120b is equal to the distance between one end of a (k+1)-th convex portion adjacent to the k-th convex portion and the bottom 120b. Therefore, it is possible to prevent the overlap between the range of the height of the line of a given convex portion 123 and the range of the height of the line of another convex portion 123.

As described above, the reference points λ₁, . . . , λ_{L} have different optical distances (optical path lengths) from a light receiving surface of the imaging unit 102. In this way, the imaging unit 102 may be focused on any one of the reference points λ₁, . . . , λ_{L} according to the position of the imaging unit 102 in the Z-axis direction. When the imaging unit 102 is focused on the reference point λ₁, the brightness of the reference point λ₁ is more than that of the other reference point λ₂ to λ_{L} in the image captured by the imaging unit 102. Therefore, the reference point λ₁ is displayed as a point indicating the maximum brightest on the measurement reference surface of the reference scale member 101. This is the same with the case in which the scale members 101A, 101B, and 101C shown in FIG. 3A, FIG. 4A, and FIG. 5A are used as instead of the reference scale member 101 shown in FIG. 2A.

The driving mechanism 103 moves the imaging unit 102 in the Z-axis direction relative to the measurement stage 104 stepwise or continuously. As such, during the period for which the imaging unit 102 is moved, the imaging unit 102 continuously captures the image of the object 105 from the upper limit to the lower limit of the set range and outputs several tens to several hundreds of captured images I₁, . . . , I_{P} (P is a positive integer) in response to instructions from the detection control unit 106. In the first embodiment, the imaging unit 102 outputs the captured images I₁, . . . , I_{P} at relative movement positions L₁, . . . , L_{P}.

The high brightness detecting unit 110 detects the brightest portion of the object 105 from the captured images I₁, . . . , I_{P} at the relative movement positions L₁, . . . , L_{P} and detects a reference point λ_{ML} indicating the maximum brightness among the reference points λ₁, . . . , λ_{L} as a point corresponding to the brightest portion. That is, the high brightness detecting unit 110 detects a pixel region indicating the maximum brightness in a partial image of the object 105 from the captured image Iₖ corresponding to each relative movement position Lₖ and detects a pixel at the reference point λ_{ML} indicating the maximum brightness from the pixel region.

The three-dimensional measuring unit 111 acquires a height value associated with the reference point λ_{ML} from the coordinate storage unit 107 and performs a height measuring process such that the height of the brightest portion is set to the height value associated with the reference point λ_{ML}. The height measuring process is performed at each of the relative movement positions L₁, . . . , L_{P}.

In some cases, the high brightness detecting unit 110 fails to detect the brightest portion of the object 105 or the high brightness detecting unit 110 skips the detection of the brightest portion. In this case, the three-dimensional measuring unit 111 may interpolate the height of the brightest portion of the object 105. Specifically, when the brightest portion is detected at an i-th relative movement position Lᵢ and a plurality of reference points as points indicating the maximum brightness is detected at a plurality of relative movement positions in the vicinity of the relative movement position Lᵢ, the three-dimensional measuring unit 111 may interpolate the height of the brightest portion at the relative movement position Lᵢ based on the heights associated with the reference points. For example, it is assumed that the reference points indicating the maximum brightness are detected at two relative movement positions Lᵢ₋₁ and Lᵢ₊₁ in the vicinity of the relative movement position Lᵢ and the heights associated with the reference points are α and β. In addition, it is assumed that pulse values (the number of control pulses supplied to a pulse control motor that moves the imaging unit 102) indicating the relative movement positions Lᵢ, Lᵢ₋₁, and Lᵢ₊₁ are Pᵢ, Pᵢ₋₁, and Pᵢ₊₁. In this case, it is possible to linearly interpolate the height γ of the brightest portion at the relative movement position Lᵢ according to the following Equation 1:

γ=β+(α−β)·(Pᵢ−Pᵢ₋₁)/(Pᵢ₊₁−Pᵢ₋₁) Equation (1)

Equation 1 is for linear interpolation. However, instead of the linear interpolation, interpolation using a polynomial or a spline curve may be performed. In this way, it is possible to compensate for the non-linearity of the driving mechanism 103.

A large amount of light reflected from a surface that faces the imaging unit 102 is incident on the light receiving surface of the imaging unit 102 and a small amount of light reflected from a surface that does not face the imaging unit 102 is incident on the light receiving surface. Therefore, the imaging unit 102 may obtain the high-brightness image of a surface that is parallel to the horizontal direction or is inclined close to the horizontal direction, but it is difficult for the imaging unit 102 to obtain the high-brightness image of a surface that is in parallel to the vertical direction or is inclined close to the vertical direction. Therefore, the surface is stored as a region that is unavailable for height detection.

As described above, the three-dimensional measuring unit 111 may detect the height of the object 105 in a pixel unit and store the detection result in a memory (not shown). In addition, the three-dimensional measuring unit 111 may determine a region that is unavailable for the detection of the height of the object 105 in a pixel unit and store the determination result in the memory. When the object 105 is a BGA (Ball Grid Array), the three-dimensional measuring unit 111 may acquire three-dimensional data indicating the height of each of a plurality of solder bumps that is arranged in an array, coplanarity, and the warping of a package.

The three-dimensional measuring apparatus 10 according to the first embodiment has the following effects.

As described above, the imaging unit 102 continuously captures the optical image of the object 105 and the optical images of a plurality of reference points of the reference scale member 101 in the same field of view IA while being moved relative to the measurement stage 104 in the Z-axis direction in which it is separated from or approaches the measurement stage. The high brightness detecting unit 110 and the three-dimensional measuring unit 111 detect the brightest portion of the object 105 and a reference point indicating the maximum brightness, which corresponds to the brightest portion, at each relative movement position and set the height of the brightest portion of the object 105 to a height associated with the detected reference point. In this way, when the positions of a plurality of reference points of the reference scale member 101 are accurately measured in advance and a measured value, which is the measurement result, is associated with each reference point, it is possible to measure the height distribution of the object 105 with high accuracy. Therefore, it is possible to accurately measure the three-dimensional shape of the object 105 in the submicron range without accurately measuring the amount of movement of the imaging unit 102 using an accurate measuring device such as an optical linear scale. Therefore, a processing cost of accurately graduating the optical linear scale is not needed. As a result, it is possible to simplify the structure of an apparatus and reduce manufacturing costs.

Even though there is a backlash, non-uniformity in frictional resistance, or variation over time in a mechanical part of the driving mechanism 103, the positions of the reference points λ₁, . . . , λ_{L} of the reference scale member 101 are constant. Therefore, it is possible to obtain high measurement accuracy.

In addition, the use of the reference scale members having the measurement reference surfaces including a plurality of convex portions shown in FIGS. 3A, 4A, and 5A makes it possible to accurately detect the reference points λ₁, λ₂, . . . provided in the convex portions from the captured image. In this way, it is possible to more accurately measure the three-dimensional shape of the object 105.

In particular, as shown in FIG. 5A, since the reference scale member 101C including the convex portions 123 extending in a direction that is inclined with respect to the bottom 120b of the triangular prism member 101 is used, it is possible to provide a plurality of reference points in the convex portions 123. In this way, the number of reference points with different heights increases, which results in an increase in the number of reference points to be focused. Therefore, it is possible to more accurately measure the three-dimensional shape of the object 105.

### Second Embodiment

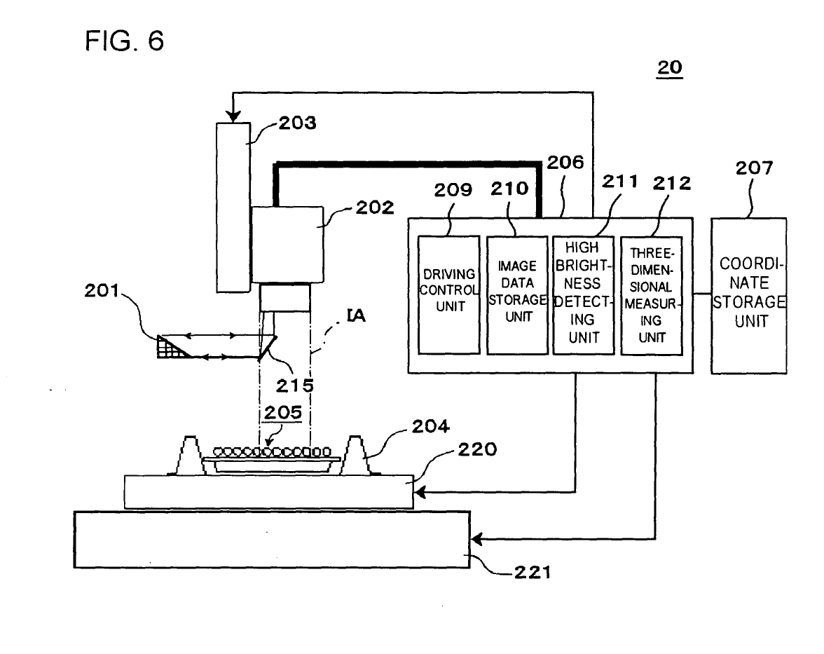

Next, a second embodiment of the invention will be described. FIG. 6 is a diagram schematically illustrating the structure of a three-dimensional measuring apparatus 20 according to the second embodiment. The three-dimensional measuring apparatus 20 includes a reference scale member 201, an imaging unit 202, a Z-axis driving mechanism 203, a measurement stage 204, a detection control unit 206, a coordinate storage unit 207, a mirror element 215, an X-axis driving mechanism 220, and a Y-axis driving mechanism 221. The detection control unit 206 includes a driving control unit 209, an image data storage unit 210, a high brightness detecting unit 211, and a three-dimensional measuring unit 212. An object 205 is placed on a mounting surface of the measurement stage (base portion) 204.

In the second embodiment, the three-dimensional measuring apparatus 20 includes an optical element 215 that forms the optical image of the reference scale member 201 on a light receiving surface of the imaging unit 202. The optical element 215 may be, for example, a mirror element that guides light reflected from the reference scale member 201 to the light receiving surface of the imaging unit 202.

The imaging unit 202 is provided so as to face the measurement stage 204 and has a function of capturing the optical image of the object 205 and the optical images of a plurality of reference points λ₁, . . . , λ_{L} of the reference scale member 201 in the same field of view IA. Two-dimensional image data of N×M pixels (N and M are positive integers) captured by the imaging unit 202 is transmitted and processed by the detection control unit 206.

The imaging unit 202 includes a solid-state imaging device, such as a CCD or a CMOS, a fixed focus lens, and a coaxial eqi-illumination mechanism (which are not shown). The coaxial eqi-illumination mechanism uniformly emits light to the object 205 that is disposed immediately below the coaxial eqi-illumination mechanism. Returning line reflected from the object 205 is detected by the light receiving surface of the imaging unit 202. At the same time, the coaxial eqi-illumination mechanism emits light to the reference scale member 201 through the optical element 215. Returning light reflected from the reference scale member 201 is detected by the light receiving surface of the imaging unit 202. The imaging unit 202 may include an optical system provided in the microscope according to the related art or an optical system capable of detecting light according to a principle, such as a light confocal method or an optical interference fringe method.

The Z-axis driving mechanism 203 has a function of moving the imaging unit 202 relative to the measurement stage 204 in the Z-axis direction in which the imaging unit 202 is separated from or approaches the measurement stage 204, in response to a control signal from the detection control unit 206. With the movement of the imaging unit 202, the focal point of the imaging unit 202 is also moved in the Z-axis direction. When the imaging unit 202 is focused on a certain portion of the surface of the object 205, the brightness of the portion in the image captured by the imaging unit 202 is more than that of other portions of the surface. Therefore, the portion is displayed as the brightest portion of the surface of the object 205.

The reference scale member 201 has the same structure as the reference scale member 101 shown in FIGS. 2A and 2B, and is made of the same material as that forming the reference scale member 101. In the second embodiment, the reference scale member 201 is fixedly arranged such that the bottom of the reference scale member 201 is vertical to the optical axis of the imaging unit 202. In addition, the reference scale member 201 is arranged independently from the imaging unit 202.

The reference points λ₁, . . . , λ_{L} on a measurement reference surface of the reference scale member 201 are arranged so as to have different optical distances (optical path lengths) from the light receiving surface of the imaging unit 202. Therefore, the imaging unit 202 may be focused on any one of the reference points λ₁, . . . , λ_{L} according to the position of the imaging unit 202 in the Z-axis direction. When the imaging unit 202 is focused on the reference point λ₁, the brightness of the reference point λ₁ is more than that of the other reference point λ₂ to λ_{L} in the image captured by the imaging unit 202. Therefore, the reference point λ₁ is displayed as a point indicating the maximum brightness on the measurement reference surface.

The X-axis driving mechanism 220 may move the measurement stage 204 in the X-axis direction (a direction vertical to the Z-axis) in response to a control signal from the driving control unit 209. The Y-axis driving mechanism 221 may move the measurement stage 204 in the Y-axis direction (a direction vertical to the X-axis and the Y-axis) in response to a control signal from the driving control unit 209. The X-axis driving mechanism 220 and the Y-axis driving mechanism 221 may move a desired region of the surface of the object 205 in the field of view of the imaging unit 202 in cooperation with each other.

The entire measurement region of the object 205 is divided into a plurality of test regions CA₁, . . . , CA_{Q} (Q is a positive integer), and the imaging unit 202 may capture the image of one test region CAₖ in the field of view IA at a time. The driving control unit 209 controls the X-axis driving mechanism 220 and the Y-axis driving mechanism 221 to sequentially move the test regions CA₁ to CA_{Q} into the field of view IA. In synchronization with the movement, the imaging unit 202 sequentially captures the images of the test regions CA₁ to CA_{Q}.

For each test region CAₖ, the Z-axis driving mechanism 203 moves the imaging unit 202 stepwise or continuously relative to the measurement stage 204 in the Z-axis direction. During a driving period for the test region CAₖ, the imaging unit 202 continuously captures the image of the test region CAₖ of the object 205 from the upper limit to the lower limit of the set range and outputs several tens to several hundreds of captured images I(1, k), . . . , I(P, k), in response to instructions from the detection control unit 206. The image data storage unit 210 stores data of the captured images I(1, k), . . . , I(P, k) transmitted from the imaging unit 202.

The high brightness detecting unit 211 approximates a discrete brightness distribution related to the relative movement position for a predetermined number of pixels to a continuous curve g (x) (where x is a continuous variable indicating the relative movement position) from the captured images I(1, k), . . . , I(P, k) read from the image data storage unit 210. It is preferable to use the known Gaussian curve or Lorenz curve as the continuous curve g(x), but the invention is not limited thereto. The high brightness detecting unit 211 uses the peak value g(x=x_{P}) of the Gaussian curve as the brightness value of the brightest portion.

For example, when the discrete brightness distribution of each pixel is approximated to the Gaussian curve g(x) from the captured images I(1, k) to I(P, k) of the test regions CAₖ, the distribution of discrete brightness values B_{i,j}(1, k), . . . , B_{i,j}(P, k) related to the discrete relative movement positions L₁, . . . , L_{P} for each pixel is approximated to the Gaussian curve g(x) (where B_{i,j}(N, k) indicates the brightness value of a pixel in an i-th row and a j-th column in the captured image of the test region CAₖ corresponding to an n-th relative movement position). The peak value g(x=x_{P}) of the Gaussian curve g(x) indicates a value that is more accurate than the maximum value of the discrete brightness values as the maximum brightness of the pixel in the i-th row and the j-th column.

In this way, the high brightness detecting unit 211 obtains a relative movement position x_{P} corresponding to the peak value g(x=_{P}) of the continuous curve g(x). In addition, the high brightness detecting unit 211 detects a reference point λ_{ML} indicating the maximum brightness from the reference points λ₁, . . . , λ_{L} as a reference point corresponding to the relative movement position x_{P}.

The three-dimensional measuring unit 212 acquires a height value associated with the reference point λ_{ML} from the coordinate storage unit 207 and sets the height of the brightest portion of the object 205 to the height associated with the reference point λ_{ML}.

The image data storage unit 210 may compose the captured images I(1, k), . . . , I(P, k) transmitted from the imaging unit 202 to generate one composite image or a plurality of composite images and store the composite image. In this case, the high brightness detecting unit 211 may detect the brightest portion of the object 205 from the composite image. In this case, it is preferable that the image data storage unit 210 generate the composite image such that the error in the angle between the X-axis direction of the X-axis driving mechanism 220 and the horizontal plane and the error in the angle between the Y-axis direction of the Y-axis driving mechanism 221 and the horizontal plane are corrected based on the previous verification result.

In some cases, the high brightness detecting unit 211 fails to detect the brightest portion of the object 205 or the high brightness detecting unit 211 skips the detection of the brightest portion. In this case, similar to the first embodiment, the three-dimensional measuring unit 212 may interpolate the height of the brightest portion of the object 205. That is, when the brightest portion is not detected at an i-th relative movement position Lᵢ but a plurality of reference points as points indicating the maximum brightness is detected at a plurality of relative movement positions in the vicinity of the relative movement position Lᵢ, the three-dimensional measuring unit 212 may interpolate the height of the brightest portion at the relative movement position Lᵢ based on the heights associated with the reference points. For example, it is assumed that reference points indicating the maximum brightness are detected at two relative movement positions Lᵢ₋₁ and Lᵢ₊₁ in the vicinity of the relative movement position Lᵢ, the heights associated with the reference points are α and β, and pulse values corresponding to the relative movement positions Lᵢ, Lᵢ₋₁, and Lᵢ₊₁ are Pᵢ, Pᵢ₋₁, and Pᵢ₊₁. In this case, it is possible to linearly interpolate the height γ of the brightest portion at the relative movement position Lᵢ according to the following Equation 2:

γ=β+(α=β)·(Pᵢ−Pᵢ₋₁)/(Pᵢ₊₁−Pᵢ₋₁) Equation (2)

Equation 2 is for linear interpolation. However, instead of the linear interpolation, interpolation using a polynomial or a spline curve may be performed. In this way, it is possible to compensate for the non-linearity of the Z-axis driving mechanism 203.

A large amount of light reflected from a surface that faces the imaging unit 202 is incident on the light receiving surface of the imaging unit 202 and a small amount of light reflected from a surface that does not face the imaging unit 202 is incident on the light receiving surface. Therefore, the imaging unit 202 may obtain the high-brightness image of a surface that is inclined close to the horizontal direction. However, it is difficult for the imaging unit 202 to obtain the high-brightness image of a surface that is inclined close to the vertical direction. Therefore, the surface is stored as a region that is unavailable for height detection.

As described above, the three-dimensional measuring unit 212 may detect the height of the object 205 in a pixel unit and store the detection result in a memory (not shown). In addition, the three-dimensional measuring unit 212 may determine a region that is unavailable for the detection of the height of the object 205 in a pixel unit and store the determination result in the memory.

The three-dimensional measuring apparatus 20 according to the second embodiment has the following effects.

As described above, the three-dimensional measuring apparatus 20 includes the optical element 215. Therefore, the imaging unit 202 may constantly capture the optical image of a portion of the object 205 and the optical images of the reference points λ₁ to λ_{L} of the reference scale member 201 in the same field of view IA even though the driving control unit 209 relatively moves the field of view IA of the imaging unit 202 on the object 205. Similar to the first embodiment, the high brightness detecting unit 211 and the three-dimensional measuring unit 212 may detect the brightest portion of the object 205 and a reference point indicating the maximum brightness, which corresponds to the brightest portion, at each relative movement position of the imaging unit 202 and set the height of the brightest portion of the object 205 to the height associated with the detected reference point. In this way, when the positions of a plurality of reference points of the reference scale member 201 are accurately measured in advance and a measured value, which is the measurement result, is associated with each reference point, it is possible to measure the height distribution of the object 205 with high accuracy. Therefore, it is possible to accurately measure the three-dimensional shape of the object 205 without accurately measuring the amount of movement of the imaging unit 202 using an accurate measuring device such as an optical linear scale. As a result, it is possible to simplify the structure of an apparatus and reduce manufacturing costs.

The embodiments of the invention have been described above with reference to the drawings, but the invention is not limited thereto. Various structures other than the above-mentioned structures may be used. For example, in the first and second embodiments, the reference scale members 101 and 201 are used only for measuring the shape of an object, but the invention is not limited thereto. The reference scale members 101 and 201 may have, for example, the function of a jig.

In the second embodiment, the X-axis driving mechanism 220 and the Y-axis driving mechanism 221 are used to drive the object 205 in the X-axis direction and the Y-axis direction. However, instead of them, driving mechanisms may be used to drive the imaging unit 202, the reference scale member 201, and the optical element 215 in the X-axis direction and the Y-axis direction.

In the above-described embodiments, each of the reference scale members 101, 101A to 101C, and 201 has a single reference measurement surface and the reference points λ₁, . . . , λ_{L} provided on the reference measurement surface have different heights. However, the invention is not limited thereto. A reference scale member having a plurality of reference measurement surfaces that is arranged in parallel to each other and has the same structure may be used. Since the reference scale member includes a plurality of reference points at the same height, it is possible to more accurately measure the three-dimensional shape of an object.

For the positions of the reference points of the reference scale members 101, 101A to 101C, and 201, for example, a linear scale with high-accuracy graduations may be used to accurately measure the heights of the reference points in advance. That is, the reference scale member 101 is arranged on the measurement stage 104 and the linear scale is attached along the Z-axis direction. In this state, the driving mechanism 103 moves the imaging unit 102 relative to the measurement stage 104 in the Z-axis direction. In this case, the graduation value of the linear scale when the imaging unit 102 is focused on each reference point (when the brightness of a portion corresponding to the reference point is the highest) may be stored in the coordinate storage unit 107. Since the linear scale is not needed in the subsequent process of measuring the three-dimensional shape, the linear scale may be removed.

It is apparent that the present invention is not limited to the above embodiments, but may be modified and changed without departing from the scope and spirit of the invention.

What is claimed is:

1. A three-dimensional measuring apparatus comprising:
a measurement stage on which an object is placed;
a reference scale member having a plurality of reference points;
an imaging unit that is arranged so as to face said measurement stage and captures an optical image of said object and optical images of said plurality of reference points in the same field of view;
a driving mechanism that moves said imaging unit relative to said measurement stage in a direction in which said imaging unit is separated from or approaches said measurement stage;
a high brightness detecting unit that detects the brightest portion of said object at each of N relative movement positions (N is an integer that is equal to or greater than 2) of said imaging unit and detects a reference point indicating the maximum brightness among said plurality of reference points, from a plurality of images that is continuously captured by said imaging unit during a driving period for which said driving mechanism relatively moves said imaging unit; and
a three-dimensional measuring unit that sets the height of said brightest portion at each of said relative movement positions to a height associated with said detected reference point.

2. The three-dimensional measuring apparatus according to claim 1,
wherein said plurality of reference points has different optical distances from a light receiving surface of said imaging unit.

3. The three-dimensional measuring apparatus according to claim 1, further comprising:
a coordinate storage unit that stores coordinates indicating the heights associated with said plurality of reference points,
wherein said three-dimensional measuring unit acquires a height value associated with said detected reference point from said coordinate storage unit.

4. The three-dimensional measuring apparatus according to claim 1,
wherein said three-dimensional measuring unit has a function of interpolating the height of said brightest portion at an i-th relative movement position among said N relative movement positions, based on the heights associated with a plurality of reference points which is detected as points indicating said maximum brightness at relative movement positions in the vicinity of said i-th relative movement position among said N relative movement positions.

5. The three-dimensional measuring apparatus according to claim 4,
wherein said three-dimensional measuring unit linearly interpolates the height of said brightest portion at said i-th relative movement position.

6. The three-dimensional measuring apparatus according to claim 1,
wherein said high brightness detecting unit approximates a discrete brightness distribution related to said relative movement positions for a predetermined number of pixels to a continuous curve, using said plurality of images continuously captured by said imaging unit during said driving period, and uses a peak value of said continuous curve as a brightness value of said brightest portion.

7. The three-dimensional measuring apparatus according to claim 1,
wherein said reference scale member is placed on said measurement stage together with said object.

8. The three-dimensional measuring apparatus according to claim 1, further comprising:
an optical element that forms an optical image of said reference scale member on a light receiving surface of said imaging unit,
wherein said reference scale member is arranged outside the field of view of said imaging unit.

9. The three-dimensional measuring apparatus according to claim 8,
wherein said optical element includes a mirror element that guides light reflected from said reference scale member to said light receiving surface.

10. The three-dimensional measuring apparatus according to claim 1, further comprising:
a horizontal driving mechanism that moves said measurement stage relative to said imaging unit in a direction orthogonal to an optical axis of said imaging unit.

11. The three-dimensional measuring apparatus according to claim 1,
wherein said reference scale member includes a bottom and a measurement reference surface that is inclined at an acute angle with respect to the bottom, and
said plurality of reference points is provided on said measurement reference surface.

12. The three-dimensional measuring apparatus according to claim 11,
wherein said measurement reference surface is a flat surface.

13. The three-dimensional measuring apparatus according to claim 11,
wherein a plurality of convex portions that includes said plurality of reference points, respectively, and is parallel to each other is formed on said measurement reference surface, and
said convex portions are continuously formed in a direction parallel to said bottom.

14. The three-dimensional measuring apparatus according to claim 11,
wherein a plurality of convex portions that includes said plurality of reference points, respectively, and is parallel to each other is formed on said measurement reference surface, and
said convex portions are continuously formed in a direction that is inclined with respect to said bottom.

15. The three-dimensional measuring apparatus according to claim 14,
wherein a distance between one end of a k-th convex portion (k is an integer) among said plurality of convex portions and said bottom is equal to a distance between one end of a (k+1)-th convex portion adjacent to said k-th convex portion among said plurality of convex portions and said bottom.

16. The three-dimensional measuring apparatus according to claim 13,
wherein said plurality of convex portions have a sawtooth cross-section.

17. The three-dimensional measuring apparatus according to claim 13,
wherein said plurality of convex portions have a corrugated surface.
